(19) United States
(12) Patent Application Publication
(10) Pub. No.: US 2024/0024203 A1
(43) Pub. Date: Jan. 25, 2024

(54) MEDICINE SUPPLYING APPARATUS

(71) Applicant: PHC Corporation, Ehime (JP)

(72) Inventors: Yoshihiko HACCHOU, Tochigi (JP); Toshiaki UETA, Tokushima (JP)

(21) Appl. No.: 18/479,603

(22) Filed: Oct. 2, 2023

Related U.S. Application Data
(63) Continuation of application No. PCT/JP2022/004494, filed on Feb. 4, 2022.

(30) Foreign Application Priority Data
Apr. 7, 2021 (JP) 2021-065344

(51) Int. Cl. A61J 7/00; B65B 1/06; B65B 1/02

(52) U.S. Cl. CPC A61J 7/0084; B65B 1/06; B65B 1/02

(57) ABSTRACT

This chemical agent supply device is provided with: a stage having a plane and penetration holes opening into the plane; and a hand distribution unit that is provided with a base part detachably attached to the stage and a conveyor that is retained by the base part and discharges a chemical agent from the penetration holes. The conveyor is provided with a plurality of buckets that have a cylindrical shape opened at both upper and lower ends thereof and move with the lower ends contacting the plane.

### TECHNICAL FIELD

The present disclosure relates to a medicine supplying apparatus.

### BACKGROUND ART

PTL 1 discloses a medicine supplying apparatus that includes a drug feeder for the user to arbitrarily place the drugs for drugs and the like that are not frequently dispensed. The drug feeder includes a plurality of storage compartments to which drugs are placed. The plurality of storage compartments is formed in a cylindrical shape and includes a shutter that opens and closes the opening edge on the lower side. The plurality of storage compartments moves in an annularly circulating manner with the shutter closed. When the storage compartment passes through an ejection position for ejecting the drug, the shutter is opened and the drug is ejected from the storage compartment.

### CITATION LIST

### Patent Literature

PTL 1

Japanese Patent Publication No. 4093856

### SUMMARY OF INVENTION

### Technical Problem

However, since the shutter is operated and the drug is ejected when the storage compartment passes through the ejection position as described above, the time for which the storage compartment passes through the ejection position cannot be set to a time shorter than the operation time of the shutter. On the other hand, it is desirable to increase the dispensing speed for the purpose of shortening the waiting time of patients and the like.

An object of the present disclosure is to increase the dispensing speed in the medicine supplying apparatus.

### Solution to Problem

To achieve the above-mentioned object, a medicine supplying apparatus in the present disclosure includes: a stage including a flat surface and a through hole that is open at the flat surface; and a manual feeding unit including a base part detachably attached to the stage, and a conveyer held by the base part and configured to eject a drug from the through hole. The conveyer includes a plurality of buckets having a cylindrical shape that is open at upper and lower ends, and configured to move in a state where the lower end is in contact with the flat surface.

### Advantageous Effects of Invention

The medicine supplying apparatus of the present disclosure can increase the dispensing speed.

### BRIEF DESCRIPTION OF DRAWINGS

FIG. 1 is a perspective view of a medicine supplying apparatus according to an embodiment of the present disclosure;

FIG. 2 is a longitudinal sectional view of the medicine supplying apparatus;

FIG. 3 is a perspective view of a manual feeding unit and a stage;

FIG. 4 is a perspective view of the stage;

FIG. 5 is a sectional view of a positioning part and a fit part;

FIG. 6 is a sectional view of a guide part and a second fit part;

FIG. 7 is a plan view of a location sensor and an attaching unit;

FIG. 8 is a bottom view of a manual feeding unit;

FIG. 9 is a sectional view taken along line IX-IX illustrated in FIG. 8;

FIG. 10 is a perspective view of a bucket;

FIG. 11 is a sectional view of a bucket according to a modification; and

FIG. 12 is a sectional view of the bucket according to the modification.

### DESCRIPTION OF EMBODIMENTS

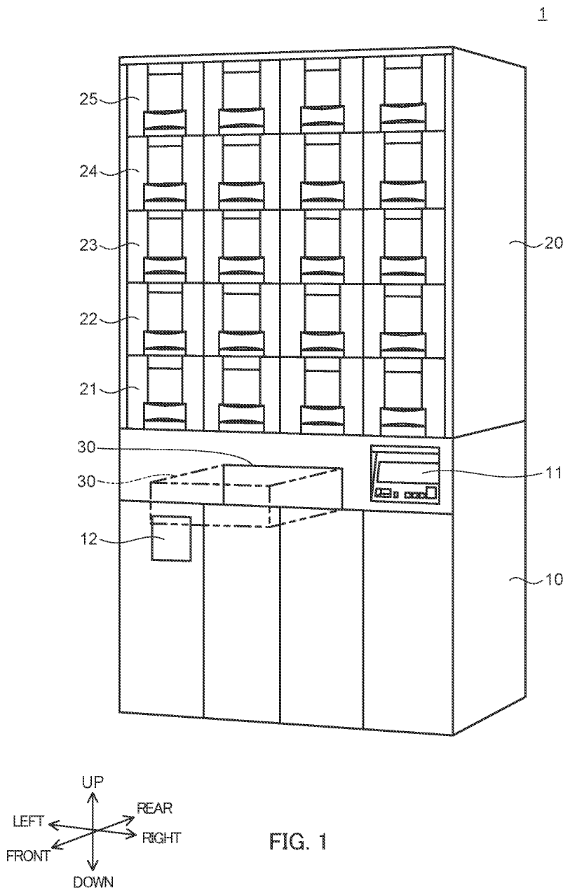

An embodiment of medicine supplying apparatus 1 of the present disclosure is described below with reference to the drawings. Note that, in the following description, the side on which operation part 11 is disposed is the front side of medicine supplying apparatus 1 and the side opposite to the front side is the rear side of medicine supplying apparatus 1 as indicated with the arrow in FIG. 1. In addition, the left side and right side as viewed from the front side of medicine supplying apparatus 1 is the left side and right side of medicine supplying apparatus 1. In addition, the side away from the surface on which medicine supplying apparatus 1 is installed is the upper side of medicine supplying apparatus 1, and the side opposite to the upper side is the lower side of medicine supplying apparatus 1.

FIG. 1 is a perspective view illustrating an exemplary medicine supplying apparatus 1. Medicine supplying apparatus 1 includes first floor part 10 and second floor part 20.

First floor part 10 includes operation part 11, and take-out part 12. In addition, first floor part 10 includes an input part (not illustrated in the drawing), a control part (not illustrated in the drawing) and the like.

Operation part 11 is an apparatus to be operated by the user, and includes a display, an operation button and the like, for example. A variety of information is input to medicine supplying apparatus 1 through operation of operation part 11 by the user.

Drugs dispensed in medicine supplying apparatus 1 are taken out from take-out part 12. Take-out part 12 includes an opening, and the user takes out drugs from the opening.

The input part is an input apparatus to which a variety of information is input from an external device. The input part is connected to a personal computer, and medical prescription information issued in medical facilities is input from the personal computer, for example.

The control part is a control apparatus that controls each part of medicine supplying apparatus 1. The control part controls operation part 11 and the like. In addition, on the basis of the medical prescription information input from the input part, the control part controls each part such that the drug designated by the medical prescription is packaged into a small package and that the drug is conveyed to take-out part 12.

Second floor part 20 includes a plurality of drawers 21 to 25. Drawers 21 to 25 are overlaid and stacked in this order in the direction from the lower side toward the upper side. A plurality of drawers is arranged in the left-right direction in each of drawers 21 to Note that, the number of the drawers in second floor part 20 is not limited to this, and a larger or smaller number of drawers may be provided in the up-down direction and left-right direction.

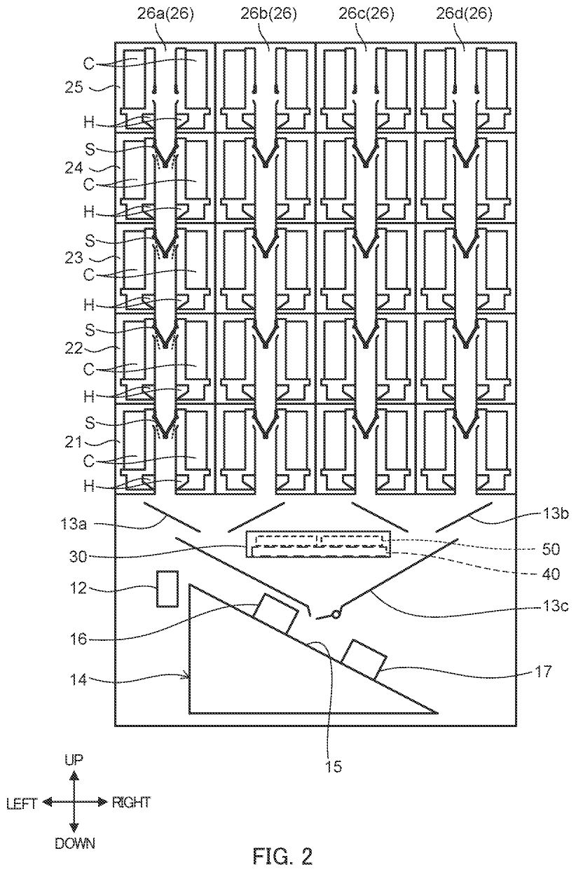

Next, internal structures of second floor part 20 and first floor part 10 are described with reference to FIG. 2. FIG. 2 is a longitudinal sectional view of medicine supplying apparatus 1.

Each of drawers 21 to 25 includes tablet case C that stores drugs and ejection part H that ejects drugs one by one from tablet case C to passage 26. The drug ejected from ejection part H is fed to first floor part 10 down through passage 26. Passage 26 penetrates drawers 21 to 25 in the up-down direction, and a plurality of (four, corresponding to first passage 26a to fourth passage 26d in the present embodiment) passages 26 corresponding to the number of drawers 21 to 25 is provided. In addition, passage 26 is provided with shutter part S.

Shutter part S is configured to temporarily retain the drug ejected by ejection part H. A plurality of shutter parts S are provided for each of first passage 26a to fourth passage 26d. Each of shutter parts S is disposed at a position corresponding to ejection part H of each of drawers 22 to 25.

Shutter part S is controlled by the control part to switch between the closed state and the open state. In FIG. 2, the closed state of shutter part S is illustrated by the solid line, and the open state of shutter part S is illustrated by the broken line. The closed state is a state of retaining the drug. The open state is a state of dropping the drug to passage 26.

Next, an operation of the above-mentioned second floor part 20 is described. In accordance with the above-described medical prescription information, a drug is ejected to ejection part H located on the upper side, and stored in shutter part S corresponding to ejection part H. Subsequently, the drug drops from the shutter part S along passage 26, and is stored in another shutter part S located on the lower side of that shutter part S. At this time, a drug is ejected from ejection part H corresponding to the shutter part S on the lower side, and thus a plurality of drugs is collected.

In this manner, drugs are sequentially dropped from one shutter part S to another shutter part S on the lower side along passage 26, and a plurality of drugs are sequentially collected in accordance with the medical prescription information. The drugs designated by the medical prescription in a collected state is fed from passage 26 to first floor part 10. In the following description, the collected drugs may also be referred to as drug group.

Note that, while one drug group is being collected, some or all of the drugs making up the next drug group may be collected at shutter part S located on the upper side of the one drug group. In this manner, with the plurality of shutter parts S, a plurality of drug groups can be efficiently collected without mixing the drugs of one drug group into other drug groups.

Next, first floor part 10 is described. First floor part 10 includes first hopper 13a, second hopper 13b, third hopper 13c, and packaging unit 14.

First hopper 13a receives the drug fed from first passage 26a and second passage 26b. Second hopper 13b receives the drug fed from third passage 26c and fourth passage 26d. First hopper 13a and second hopper 13b feed the receive drug to the third hopper 13c.

Third hopper 13c receives the drug fed from first hopper 13a and second hopper 13b. Third hopper 13c feeds the drug to packaging unit 14.

Packaging unit 14 packages a plurality of drugs fed from third hopper 13c. Packaging unit 14 includes conveyance part 15, printer 16, and sealing apparatus 17.

Conveyance part 15 is an apparatus that rolls out packaging paper from a roller (not illustrated in the drawing) around which belt-shaped packaging paper folded in two is wound, and conveys the rolled-out packaging paper toward sealing apparatus 17. The drug fed from third hopper 13c is put on the packaging paper and conveyed toward sealing apparatus 17 together with the packaging paper.

Printer 16 is a printer that prints, on the surface of the packaging paper rolled-out from the roller, the patient's name, the name of the drug supplied to the packaging paper, the date and time of the dose, and the like, for example.

Sealing apparatus 17 is an apparatus for sealing the packaging paper wrapping the drug.

The packaging paper in which the drug is sealed is cut at a predetermined timing, and conveyed to take-out part 12 by a predetermined apparatus, for example.

In addition, the first floor part further includes drawer 30. Drawer 30 is disposed to be drawable to the front side from first floor part 10. Drawer 30 is disposed between first hopper 13a and second hopper 13b (FIG. 2). Drawer 30 is formed in a rectangular frame shape that is open on the upper side and lower side in plan view. Stage 40 and manual feeding unit 50 are housed in drawer 30. Stage 40 is fixed to drawer 30. Manual feeding unit 50 is detachably attached to stage 40.

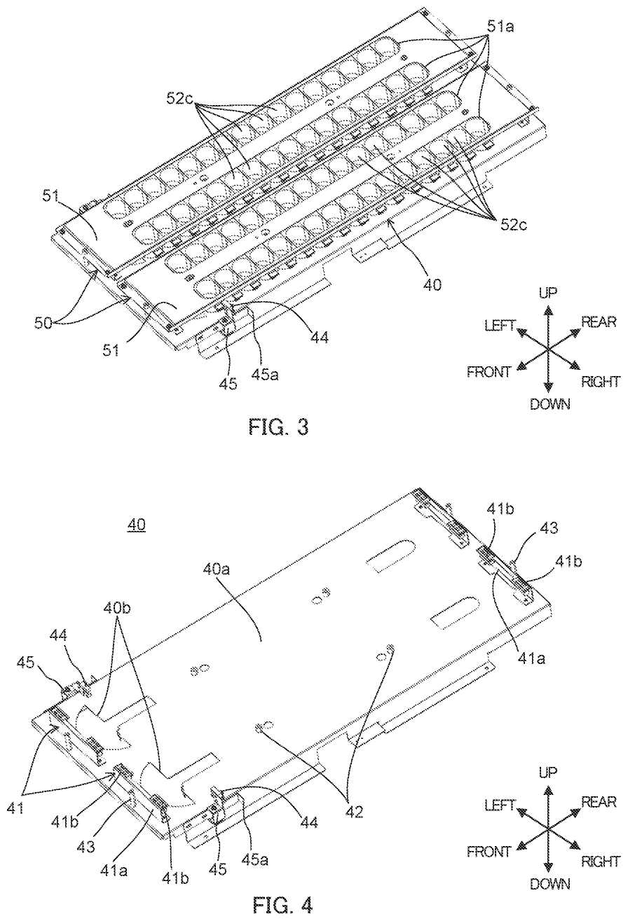

Stage 40 and manual feeding unit 50 are described below with reference to FIGS. 3 to 10. FIG. 3 illustrates a state where two manual feeding units 50 are attached to stage

Note that, the directions of stage 40 and manual feeding unit 50 represented by the arrow in FIG. 3 correspond to the direction of medicine supplying apparatus 1 illustrated in FIG. 1.

Stage 40 is formed in a rectangular shape with flat surface 40a in plan view (FIG. 4). Stage 40 is made of metal. Stage 40 includes through hole 40b that opens at flat surface 40a. Through holes 40b are formed for the number of manual feeding units 50 that are attachable to stage 40. The drug is fed to third hopper 13c via through hole 40b. Stage further includes attaching part 41, positioning part 42, guide part 43, and location sensor 44.

Attaching part 41 is configured to detachably attach base part 51 (described later) making up manual feeding unit 50 (FIGS. 4 and 6). Attaching parts 41 are disposed on stage 40 side by side in the left-right direction for the number of base parts 51. Attaching part 41 includes a pair of plate members 41a, and holding part 41b.

Each of the pair of plate members 41a is formed in a U-shape in a cross section, and is disposed such that open ends face each other at the front end portion and the rear end portion of stage 40. A plurality of holding parts 41b with a configuration including a permanent magnet are disposed at the upper end portion of plate member 41a. When base part 51 is put on the top surface of holding part 41b, base part 51 is held with the magnetic force of holding part 41b. Two holding parts 41b are disposed for each plate member 41a, but naturally the number of holding parts 41b is not limited to two.

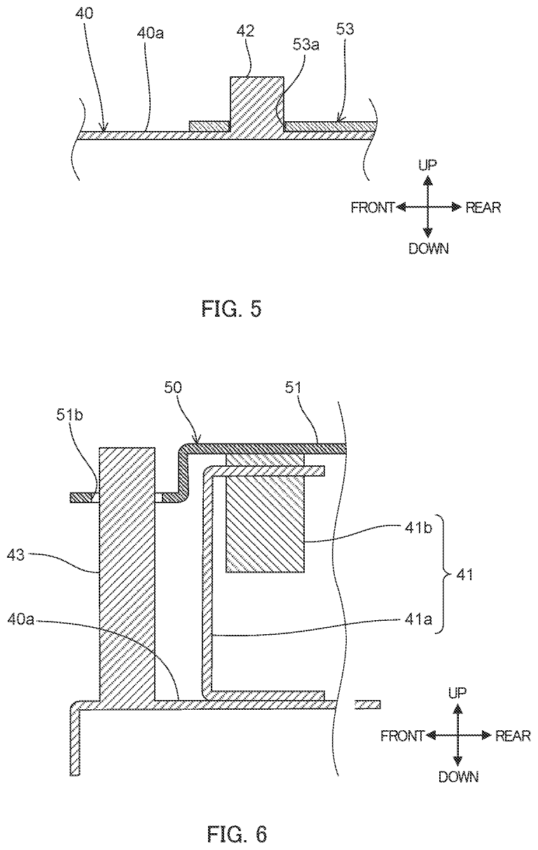

Positioning part 42 is configured to set the position where base part 51 is attached by fitting to fit part 53a described later (FIGS. 4 and 5). A plurality of positioning parts 42 is disposed side by side in the front-rear direction between the pair of plate members 41a. Positioning part 42 is formed in a cylindrical shape protruding upward from flat surface 40a. The protruding end of positioning part 42 is lower than the upper end of attaching part 41. Note that, two positioning parts 42 are provided, but naturally the number of two positioning parts 42 is not limited to two.

Guide part 43 is configured to guide positioning part 42 to fit part 53a by fitting to second fit part 51b described later (FIGS. 4 and 6). Guide parts 43 are disposed on the outside of the pair of plate members 41a in the front-rear direction. Guide part 43 is formed in a cylindrical shape protruding upward from flat surface 40a. The height of the protruding end of guide part 43 from flat surface 40a is approximately equal to the height of the upper end of attaching part 41 from flat surface 40a. Note that, two guide parts 43 are provided, but naturally the number of guide parts 43 is not limited to two.

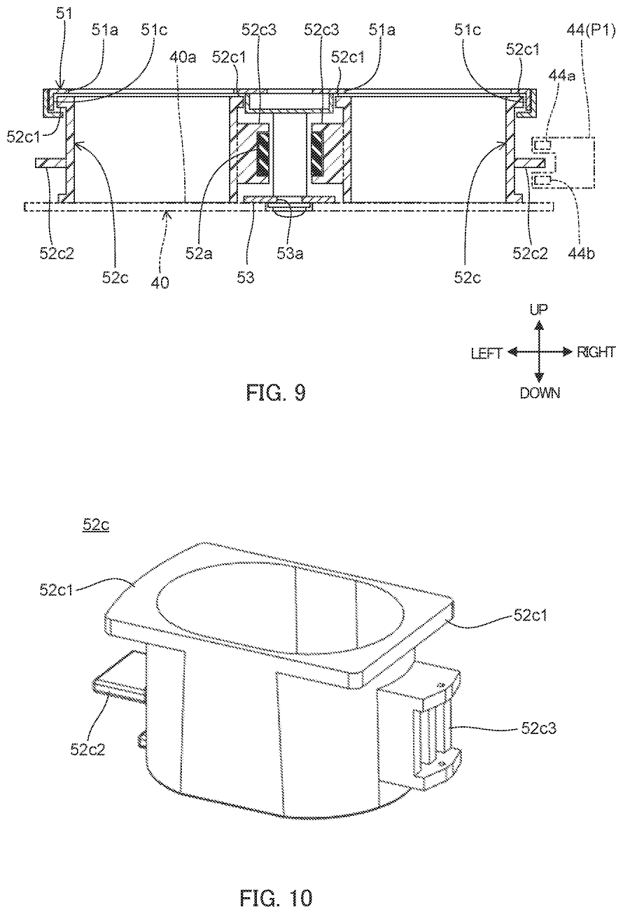

Location sensor 44 is configured to detect the position of bucket 52c described later (FIGS. 4, 7, and 9). Location sensor 44 is a photointerrupter, for example. Location sensor 44 is formed in a U-shape with light emission part 44a and light reception part 44b provided at both end portions, and disposed to be open toward the lateral side at stage 40. With protruding plate 52c2 of bucket 52c located between light emission part 44a and light reception part 44b, location sensor 44 detects the position of bucket 52c (FIG. 9). Location sensor 44 is attached to stage 40 for the number of base parts 51 through attaching unit 45. The detection signal of location sensor 44 is output to the control part.

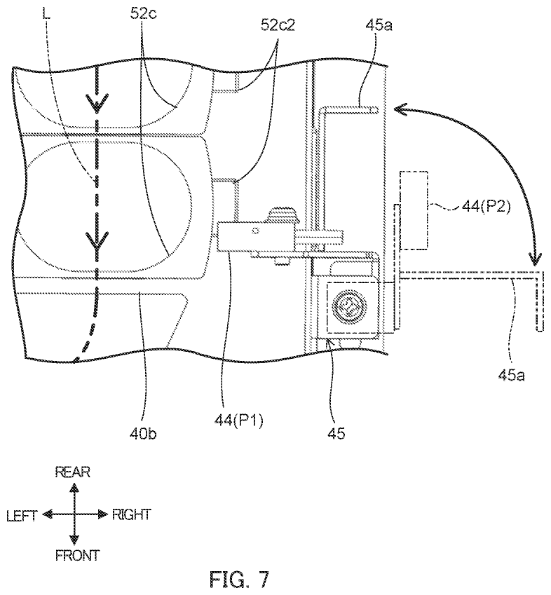

Attaching unit 45 is configured to attach location sensor 44 to stage 40 in a displaceable manner between detection position P1 and attaching/detaching position P2 (FIG. 7). Detection position P1 is a position where location sensor 44 is located above flat surface 40a and location sensor 44 detects the position of bucket 52c. Attaching/detaching position P2 is a position where location sensor 44 is outside the upper side of flat surface 40a. When location sensor 44 is located at attaching/detaching position P2, protruding plate 52c2 of bucket 52c is not located between light emission part 44a and light reception part 44b.

Attaching unit 45 is provided such that when grip 45a of attaching unit 45 is operated by the user in the solid arrow direction illustrated in FIG. 7, location sensor 44 moves between detection position P1 and attaching/detaching position P2. Location sensor 44 located at detection position P1 detects protruding plate 52c2 of one bucket 52c of a plurality of buckets 52c described later (FIGS. 7 and 9).

Separately from the plurality of drugs fed from second floor part 20, manual feeding unit 50 adds, to the plurality of drugs, drugs not frequently dispensed, for example. In manual feeding unit 50, drugs are manually placed by the user, and the drugs are fed to third hopper 13c via through hole 40b (details are described later).

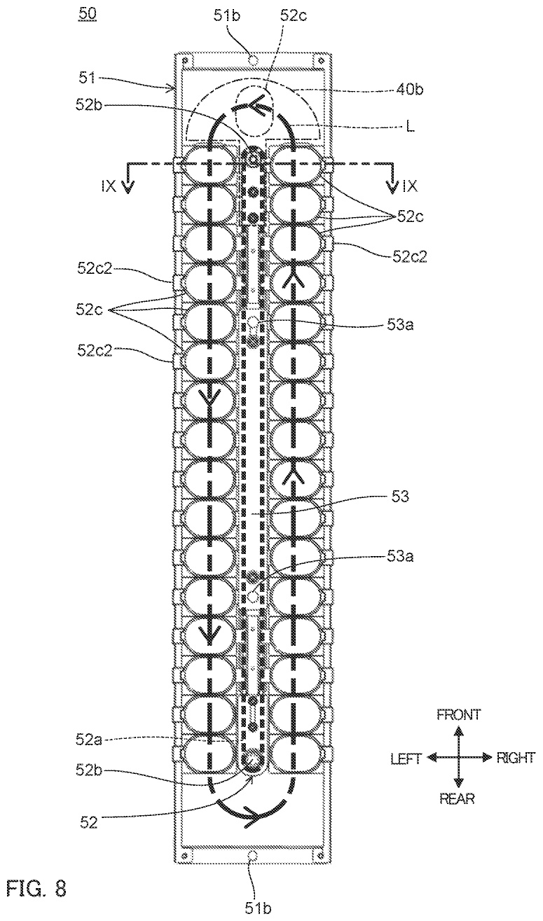

Two manual feeding units 50 are attached to stage 40 (FIG. 3). Note that, naturally, the number of manual feeding units 50 attached to stage 40 is not limited to two. As illustrated in FIGS. 3, 5 and 10 (mainly in FIGS. 8 and 9), manual feeding unit 50 includes base part 51, conveyer 52, and bottom plate part 53.

Base part 51 is detachably attached to stage 40 through attaching part 41. Base part 51 is composed of metal, and formed in a rectangular shape in plan view. Base part 51 includes two openings 51a, second fit part 51b, and guide part 51c.

Two openings 51a are formed to extend in the front-rear direction, and formed side by on both sides in the left-right direction (FIGS. 3 and 9). Second fit part 51b is a through hole to which guide part 43 provided in stage 40 is fit (FIGS. 6 and 8). Second fit part 51b is formed at a position where whether guide part 43 is inserted to second fit part 51b can be visually recognized from above base part 51. More specifically, at base part 51, second fit part 51b is formed at a position where it is visually recognizable from above base part 51 at the front end portion on the front side of opening 51a and at the rear end portion on the rear side of opening 51a. Note that, the front end portion and rear end portion of base part 51 are provided in a separate manner on the lower side of the upper end surface of base part 51 (FIG. 6).

Guide part 51c is extended in the front-rear direction at the both side end portions of base part 51 in the left-right direction and formed in a U-shape in cross section with open ends facing each other (FIG. 9). The flange part 52c1 of the plurality of buckets 52c is located inside guide part 51c.

Conveyer 52 is held by base part 51, and configured to eject the drug from through hole 40b (details are described later). Conveyer 52 includes belt 52a, sprocket 52b, and the plurality of buckets 52c.

Belt 52a is an endless belt formed in an annular shape. Belt 52a is disposed to extend in the front-rear direction at a center portion in the left-right direction on the lower side of base part 51 (FIGS. 8 and 9). Sprocket 52b operates belt 52a when engaged with belt 52a and rotated. Two sprockets 52b are disposed side by side in the front-rear direction (FIG. 8).

In the state where base part 51 is attached to stage 40, one sprocket 52b of the two sprockets 52b fits to the output shaft of a motor (not illustrated in the drawing). When the motor is driven, sprocket 52b, and in turn, belt 52a operate. Note that, the motor is disposed on the side opposite to flat surface 40a in stage 40. The motor is controlled by the control part.

The plurality of buckets 52c is made of resin, and formed in a cylindrical shape with upper and lower ends open (FIGS. 7 and 10). The plurality of buckets 52c includes flange part 52c1, protruding plate 52c2, and engaging portion 52c3.

Flange part 52c1 is formed to protrude radially outward in the horizontal direction at the upper end portion of bucket 52c (FIG. 9). Protruding plate 52c2 is formed such that the plate surface protrudes radially outward in a direction approximately orthogonal to the up-down direction on one side of the circumferential side surface of bucket 52c in the left-right direction.

Engaging portion 52c3 is formed to engage with belt 52a on the other side of the circumferential side surface of bucket 52c in the left-right direction. Bucket 52c is attached to belt 52a when engaging portion 52c3 engages with belt 52a.

The plurality of buckets 52c is attached along the outer periphery of belt 52a at even intervals (FIG. 8). When the plurality of buckets 52c is located outside with respect to belt 52a in the left-right direction, the plurality of buckets 52c are in contact with each other in the front-rear direction. In addition, the position where all of the plurality of buckets 52c are located outside with respect to belt 52a in the left-right direction and do not overlap through hole 40b is the initial position of the plurality of buckets 52c (FIG. 8).

When the plurality of buckets 52c is located at the initial position, the opening of the upper end of the plurality of buckets 52c is located inside opening 51a of base part 51 (FIG. 3), and protruding plate 52c2 is located outside in the left-right direction as viewed from belt 52a (FIG. 8).

When belt 52a is operated by the motor counterclockwise in FIG. 8 from the state where the plurality of buckets 52c is located at the initial position, the plurality of buckets 52c moves counterclockwise in FIG. 8. When the plurality of buckets 52c moves, one bucket 52c of the plurality of buckets 52c also moves on the upper side of through hole 40b so as to overlap through hole 40b of stage 40 on the front side of belt 52a as illustrated with the two-dotted line in FIG. 8.

Since belt 52a is disposed in an annular shape, locus L of the movement of the plurality of buckets 52c is an annular shape. In this manner, base part 51 holds the plurality of buckets 52c such that locus L of the movement of the plurality of buckets 52c is an annular shape.

In addition, in the state where base part 51 is attached to stage 40, the lower end of the plurality of buckets 52c is in contact with flat surface 40a (FIGS. 3 and 9). In the state where the lower end of the plurality of buckets 52c is in contact with flat surface 40a, the plurality of buckets 52c moves. In addition, of the plurality of buckets 52c located at the initial position, protruding plate 52c2 of bucket 52c that moves on the upper side of through hole 40b first when the belt 52a is driven is detected by location sensor 44 (FIG. 7).

Bottom plate part 53 is disposed below belt 52a. Bottom plate part 53 includes fit part 53a where positioning part 42 fits (FIGS. 5 and 8). Fit part 53a is disposed so as to be aligned in the front-rear direction in a manner corresponding to positioning part 42. In addition, bottom plate part 53 is provided such that in the state where base part 51 is attached to stage 40, it makes contact with flat surface 40a and fit part 53a is located at the base end portion of positioning part 42 (FIG. 5).

In addition, fit part 53a is disposed inside locus L of the movement of the plurality of buckets 52c (FIG. 8). Thus, in the state where base part 51 is attached to stage 40, positioning part 42 is also disposed inside locus L of the movement of the plurality of buckets 52c. Note that, since fit part 53a is covered with base part 51, the user cannot visually recognize fit part 53a from above base part 51.

In addition, the fitting gap between positioning part 42 and fit part 53a is smaller than the fitting gap between guide part 43 and second fit part 51b. Note that, guide part 43 and second fit part 51b are disposed outside locus L of the movement of the plurality of buckets 52c (FIGS. 6 and 8).

Next, a method of detaching manual feeding unit 50 from stage 40 is described. In the state where manual feeding unit 50 is attached to stage 40 (FIG. 3), location sensor 44 is located at detection position P1.

First, the user moves the position of location sensor 44 from detection position P1 to attaching/detaching position P2 (FIG. 7). In this manner, when detaching manual feeding unit 50 from stage 40, location sensor 44 can be prevented from being caught by protruding plate 52c2 of bucket 52c. Subsequently, the user pulls base part 51 upward against the magnetic force of holding part 41b. In this manner, base part 51, and in turn, manual feeding unit 50, are detached from stage 40.

Next, a method of attaching manual feeding unit 50 to stage 40 is described. In the state where manual feeding unit 50 is detached from stage 40, location sensor 44 is located at attaching/detaching position P2.

First, through visual recognition, the user disposes base part 51 on stage 40 so as to insert guide part 43 of stage 40 to second fit part 51b of base part 51. When guide part 43 is inserted to second fit part 51b, the position of fit part 53a and the position of positioning part 42 approximately overlap each other in the vertical direction.

Further, the user fine-tunes the position of base part 51 so as to insert positioning part 42 to fit part 53a. When positioning part 42 is inserted to fit part 53a, base part 51 makes contact with holding part 41b. Further, base part 51 is held by holding part 41b with the magnetic force of holding part 41b. At this time, the lower end of the plurality of buckets 52c is in contact with stage 40 of flat surface 40a. Finally, the user moves the position of location sensor 44 from attaching/detaching position P2 to detection position P1. In this manner, base part 51, and in turn, manual feeding unit 50, are attached to stage 40.

In this manner, base part 51, and in turn, manual feeding unit 50, are detachably attached to stage 40. When attaching manual feeding unit 50 to stage 40, the user cannot visually recognize fit part 53a, but with guide part 43 inserted to second fit part 51b, fit part 53a is guided to positioning part 42. Thus, the user can easily attach manual feeding unit to stage 40.

In addition, fit part 53a and positioning part 42 are disposed inside locus L of the movement of the plurality of buckets 52c. Fit part 53a and positioning part 42 disposed inside locus L are close to the plurality of buckets 52c in comparison with fit part 53a and positioning part 42 disposed outside locus L. Further, since fit part 53a is located at the base end portion of positioning part 42, the non-uniformity of the position of fit part 53a due to the inclination of positioning part 42 is suppressed. Thus, the user can accurately position base part 51, and in turn, manual feeding unit 50, with respect to stage 40.

Next, an operation of supplying drugs by manual feeding unit 50 is described. In the state where manual feeding unit 50 is attached to stage 40, manual feeding unit 50 is housed in drawer 30. First, manual feeding unit 50 sets the plurality of buckets 52c at the initial position.

More specifically, the control part stops the motor when the state is changed from the state where location sensor 44 is not detecting protruding plate 52c2 of bucket 52c to the state where protruding plate 52c2 is detected in the state where the plurality of buckets 52c is moving with belt 52a driven. At this time, the plurality of buckets 52c is located at the initial position (FIGS. 7 and 8).

Subsequently, in the state where drawer 30 is drawn, i.e., the state where two openings 51a and the plurality of buckets 52c can be visually recognized, the user places drugs into the plurality of buckets 52c in accordance with medical prescription information. At this time, in accordance with the order of movement of the plurality of buckets 52c on the upper side of through hole 40b, the drugs are placed into the plurality of buckets 52c. Upon completion of the placement of the drugs, the user closes drawer 30.

The control part operates second floor part 20 in accordance with the medical prescription information input from the input part, and operates manual feeding unit 50 in accordance with the operation of second floor part 20 such that a plurality of drugs is collected in accordance with the medical prescription information.

At the timing when second floor part 20 operates and the drug group as the collection of the plurality of drugs is fed to third hopper 13c, the drugs corresponding to the drug group are ejected from manual feeding unit 50. More specifically, when belt 52a is driven in accordance with the operation of second floor part 20, the plurality of buckets 52c moves. With one bucket 52c of the plurality of buckets 52c located on the upper side of through hole 40b, the drug placed in that bucket 52c is ejected from through hole 40b. The drug ejected from through hole 40b is received by third hopper 13c, and fed to the packaging unit together with the drug group fed from second floor part 20.

In this manner, when the drug is placed in the plurality of buckets 52c, the plurality of buckets 52c moves, and one bucket 52c of the plurality of buckets 52c passes above through hole 40b, the drug is ejected from through hole 40b. In addition, the plurality of buckets 52c does not include a part (e.g., a shutter) that operates for ejecting the drug. Thus, when through hole 40b is located above upward bucket 52c, manual feeding unit 50 can immediately eject the drug from that bucket 52c. Thus, it is possible to avoid a situation where the drug passes through hole 40b without being dropped from bucket 52c even when the movement speed of the plurality of buckets 52c increases. Thus, the dispensing speed can be increased.

In addition, the plurality of buckets 52c moves above flat surface 40a of state stage in the state where the drug is placed. Thus, the powder of the drug may adhere to the inner surface of bucket 52c and/or the flat surface 40a of stage 40.

However, manual feeding unit 50 and stage 40 are configured in an easily detachable manner as described above. Thus, the user can easily remove the powder adhered on the inner surface of bucket 52c by performing air blow to manual feeding unit 50 detached from stage 40, for example. In addition, the user can easily wipe off the powder adhered on flat surface 40a of stage 40 in the state where manual feeding unit 50 is detached. Thus, stage 40 and manual feeding unit 50, and in turn, medicine supplying apparatus 1, are highly cleanable.

The present disclosure is not limited to the forms described so far. Various modifications of the embodiments are also included within the scope of the present disclosure, as long as they do not depart from the gist of this disclosure.

For example, holding part 41b includes a permanent magnet, but may have a configuration provided with no permanent magnet. In this case, for example, holding part 41b may be provided with a hook (not illustrated in the drawing) making up a snap fit, and base part 51 may be provided with a catching part (not illustrated in the drawing) to which the hook is caught. In addition, it is possible to further provide a clip (not illustrated in the drawing) for sandwiching the fixing base part 51 and plate member 41a in the state where base part 51 is disposed at stage 40. Base part 51 is fixed to stage 40 by fixing base part 51 and plate member 41a with the clip. When the clip is detached, base part 51, and in turn, manual feeding unit 50, can be detached from stage 40.

In addition, positioning part 42 is provided in stage 40 and fit part 53a is provided in bottom plate part 53 as described above. Alternatively, positioning part 42 may be provided to protrude downward from bottom plate part 53 and fit part 53a may be provided to stage 40.

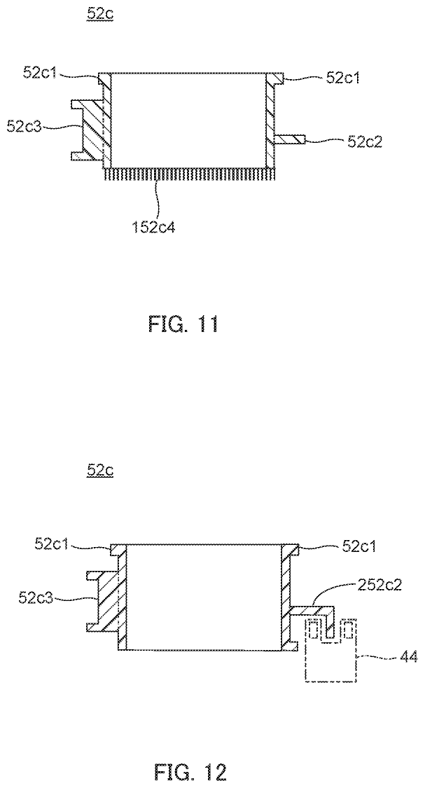

In addition, at least one of the pair of positioning part 42 and fit part 53a and the pair of guide part 43 and second fit part 51b may not be provided. In addition, as illustrated in FIG. 11, a brush-shaped opening edge that makes

contact with flat surface 40a may be formed in at least one bucket 52c of the plurality of buckets 52c. Specifically, resin brush 152c4 is provided along the periphery of the lower end portion of bucket 52c. By moving the plurality of buckets 52c in the state where drawer is pulled out, the powder adhered to flat surface 40a can be removed by brush 152c4, and the powder can be ejected to the outside from through hole 40b.

In addition, as illustrated in FIG. 12, protruding plate 252c2 of bucket 52c may be formed in an L-cross-sectional shape that radially outwardly protrudes to bucket 52c and then bends downward. In this case, location sensor 44 formed in a U-shape is disposed to be open upward, and detects protruding plate 252c2 at the portion bending downward. In this manner, when detaching manual feeding unit 50 from stage 40, location sensor 44 can be prevented from being caught by protruding plate 252c2 without moving location sensor 44. Thus, the mechanism for displacing location sensor 44 in attaching unit 45, and the procedure of displacing location sensor 44 when attaching/detaching manual feeding unit 50 with respect to stage 40 are unnecessary.

This application is entitled to and claims the benefit of Japanese Patent Application No. 2021-065344 filed on Apr. 7, 2021, the disclosure each of which including the specification, drawings and abstract is incorporated herein by reference in its entirety.

### INDUSTRIAL APPLICABILITY

The present disclosure is widely applicable to medicine supplying apparatuses.

### REFERENCE SIGNS LIST

1 Medicine supplying apparatus
30 Drawer
40 Stage
40a Flat surface
40b Through hole
41b Holding part
42 Positioning part
43 Guide part
50 Manual feeding unit
51 Base part
52 Conveyer
52c Bucket
53a Fit part
152c4 Brush
L Locus

1. A medicine supplying apparatus comprising:
a stage including a flat surface and a through hole that is open at the flat surface; and
a manual feeding unit including a base part detachably attached to the stage, and a conveyer held by the base part and configured to eject a drug from the through hole,
wherein the conveyer includes a plurality of buckets having a cylindrical shape that is open at upper and lower ends, and configured to move in a state where the lower end is in contact with the flat surface.

2. The medicine supplying apparatus according to claim 1,
wherein the base part holds the conveyer such that a locus of a movement of the plurality of buckets has an annular shape, and
wherein the stage includes a positioning part inside the locus, the positioning part being configured to set a position where the base part is attached by being fit to a fit part of the base part.

3. The medicine supplying apparatus according to claim 2, wherein the stage includes a guide part outside the locus, the guide part being configured to guide the positioning part to the fit part.

4. The medicine supplying apparatus according to claim 1, wherein an opening edge that makes contact with the flat surface is formed in a brush shape in at least one bucket of the plurality of buckets.
